(19) United States
(12) Patent Application Publication
(10) Pub. No.: US 2013/0228355 A1
(43) Pub. Date: Sep. 5, 2013

(54) POWER TOOL

(71) Applicant: BLACK & DECKER INC., Newark, DE (US)

(72) Inventors: Brent A. KUEHNE, Red Lion, PA (US); Michael CANNALIATO, Bel Air, MD (US); Ashok Samuel BASKAR, Lutherville, MD (US); Trevor KOENIG, Lancaster, PA (US); Steven McCLASKEY, North Las Vegas, NV (US); Jason McROBERTS, Windsor, PA (US)

(21) Appl. No.: 13/863,018

(22) Filed: Apr. 15, 2013

Related U.S. Application Data
(63) Continuation-in-part of application No. 13/530,629, filed on Jun. 22, 2012.
(60) Provisional application No. 61/610,268, filed on Mar. 13, 2012.
(60) Provisional application No. 61/508,962, filed on Jul. 18, 2011.
(60) Provisional application No. 61/788,627, filed on Mar. 15, 2013.

(51) Int. Cl. B25F 3/00

(52) U.S. Cl. CPC B25F 3/00
USPC 173/29

(57) ABSTRACT

A power tool including a power tool base unit with a motor surrounded by a motor housing a first coupler operably connected to the motor and a ledge. An attachment head is removably attached to the base unit, the attachment head including a second coupler, the first and second couplers being coupled together to transfer rotational motion from the motor to the attachment head. An angle between a longitudinal axis of the handle and a longitudinal axis of the motor is between 50 and 120 degrees. The ledge extends outwardly from the power tool base in a direction towards the attachment head in a direction substantially parallel to the longitudinal axis of the motor.

### CROSS REFERENCE TO RELATED APPLICATIONS

This application is a continuation-in-part of U.S. patent application Ser. No. 13/530,629, filed Jun. 22, 2012. This application also claims the benefit of U.S. Patent Application No. 61/610,268 filed Mar. 13, 2012; U.S. Patent Application No. 61/508,962 filed Jul. 18, 2011; and U.S. Patent Application No. 61/788,627, filed Mar. 15, 2013. The entire disclosures of each of the above references are incorporated herein by reference.

### BACKGROUND OF THE INVENTION

In order to increase the ease of use and flexibility, some handheld power tools have allowed interchangeability of tool heads. Permitting interchangeability of the tool heads, while keeping the same tool body, allows for the same tool body to operate as a variety of different tools—such as a drill, drill/driver, circular saw, sander, jigsaw, etc.

There have been various attempts made to make such power tools with interchangeable heads. Such previous attempts have met with varying amounts of success.

In general, different tools have different shapes for ergonomic and other reasons. Accordingly, one challenge when making a power tool with interchangeable heads is to make one tool body ergonomic for use with a variety of different tools. This may be particularly important when contemplating the design of the tool when it is being used as a drill, since a drill is a well known and widely used power tool. When a user is using a drill head and using the power tool as a drill, the user wants the look, feel and comfort of a stand-alone drill. Additionally, when the drill head is removed and a sander head, for example, is attached to the power tool body such that the power tool is now intended to operate as a sander, the user wants the sander to operate comfortably and ergonomically.

Furthermore, because the tool head is removable, there are challenges with supporting the tool head. In some power tools with removable heads, the tool head has been provided with extra support by having a dual or D-shaped handle.

In those previous attempts, the tool handle and trigger are far back from where the tool head is attached to the tool body and the work surface when a pistol grip is employed. When the trigger is far back from the work surface, it is difficult for a user to control the tool. Particularly, the user's hand in these cases is far from the work surface. That makes it difficult for a user to judge where the tool will hit the work surface.

Additionally, much of the weight in the previous attempts is forward of the connection between the tool base unit and tool head. This tends to cause the tool to tend to rotate out of a users hand/grip.

It is therefore beneficial to provide an improved power tool system with interchangeable tool heads.

### SUMMARY OF THE INVENTION

According to one aspect, an embodiment of the present application includes a power tool including a power tool body, the power tool body including a motor surrounded by a motor housing, a trigger for activating the motor, a foot, a single handle disposed between the motor housing and the foot and a ledge where the handle meet; an attachment head removably attached to the power tool body; the angle between a longitudinal axis of the handle and a longitudinal axis of the motor being between 65 and 115 degrees. The ledge may be substantially parallel to the longitudinal axis of the motor and the attachment head is at least partially supported by the ledge.

The attachment head may be a sander head and a distance from an action point of the trigger to a work surface may be less than 110 mm.

There may be at least two attachment heads which may be selectively attached and removed from the base unit and wherein when each of the at least two attachment heads is attached to the base unit, a distance from an action point of the trigger to a work surface is less than 150 mm.

The at least two attachment heads may include a drill head and a sander head.

The at least two attachment heads may include a drill head a sander head and a saw head.

At least two attachment heads which may be selectively attached and removed from the base unit and wherein when each of the at least two attachment heads is attached to the base unit, a distance from an action point of the trigger to a work surface may be less than 110 mm.

The at least two attachment heads may include a drill head and a sander head.

A center of gravity of the tool when either of the two tool heads is connected to the base unit may be less than 30 mm forward of an interface where the base unit and the tool heads meet.

A center of gravity of the tool when either of the two tool heads may be connected to the base unit is less than 20 mm forward of an interface where the base unit and the tool heads meet.

According to another aspect, an embodiment includes a power tool with a power tool body, the power tool body including a motor surrounded by a motor housing, a trigger for activating the motor, a foot, a single handle disposed between the motor housing and the foot, the angle between a longitudinal axis of the handle and a longitudinal axis of the motor being between 65 and 115 degrees; an attachment head is removably attached to the power tool body; the power tool body and the power tool head define an interface surface where the power tool body and the power tool head meet; and the trigger lies on a line that runs along the interface surface.

At least two attachment heads may be selectively attached and removed from the base unit and wherein when each of the at least two attachment heads is attached to the base unit and a distance from an action point of the trigger to a work surface may less than 150 mm.

The base unit may include a first coupler and the tool head comprises a second coupler, the first and second couplers being coupled together to transfer rotational motion from the motor to the tool head and a motor mount may be attached to the motor and a plate is attached to a rear face of the tool head and the motor mount and the plate have complementary alignment features which align the first and second couplers.

According to another aspect, an exemplary embodiment includes a kit comprising a first tool body having a first motor housing and a first handle, the first handle disposed substantially mid-way between a front end and a rear end of the first motor housing, a DC motor having a first output shaft disposed within the motor housing, the first output shaft extending along a first output shaft axis; a second tool body having a second motor housing and a second handle, the second handle disposed substantially mid-way between a front end and a rear end of the second motor housing; an AC motor having a second output shaft disposed within the second motor housing, the second output shaft extending along a second output shaft axis; a drill tool head removably attachable to both the first tool body and the second tool body, the drill tool head including a drill tool head driven shaft in driving engagement with the first output shaft when the drill tool head is attached to the first tool body and in driving engagement with the second output shaft when the drill tool head is attached to the second tool body, the drill tool head driven shaft in driving engagement with a drill tool head output spindle, the drill tool head output spindle extending along an axis which is substantially parallel to the first output shaft axis when the drill tool head is attached to the first tool body and along an axis which is substantially parallel to the second output shaft axis when the drill tool head is attached to the second tool body; and a sander tool head removably attachable to both the first tool body and the second tool body, the sander tool head including a sander tool head driven shaft in driving engagement with the first output shaft when the sander tool head is attached to the first tool body and with the second output shaft when the sander tool head is attached to the second tool body, the sander tool head driven shaft in driving engagement with a sander platen, the sander platen having a sanding surface which extends substantially parallel to the first output shaft axis when the sander tool head is attached to the first tool body and to the second output shaft axis when the sander tool head is attached to the second tool body.

When the sander tool head is attached to either the first tool body or the second tool body to form a power sander, and the power sander is set down with the sander platen resting on a work surface, the power sander may rest stably on the work surface.

When the sander tool head is attached to the second tool body at a forward surface of the second motor housing as defined relative to a region where the second handle extends from the second motor housing to thereby form a power sander, the percentage of the total combined weight of the second motor housing and the sander tool head which is disposed rearwardly of a rearwardmost location of the region may be in the range of 10-50%.

When the sander tool head is attached to the second tool body at a forward surface of the second motor housing as defined relative to a region where the second handle extends from the second motor housing to thereby form a power sander, the percentage of the total combined weight of the second motor housing and the sander tool head which is disposed rearwardly of a forwardmost location of the region may be in the range of 25-75%.

When the drill tool head is attached to the second tool body at a forward surface of the second motor housing as defined relative to a region where the second handle extends from the second motor housing to thereby form a power drill, the percentage of the total combined weight of the second motor housing and the drill tool head which is disposed rearwardly of a rearwardmost location of the region may be in the range of 10-50%.

When the drill tool head is attached to the second tool body at a forward surface of the second motor housing as defined relative to a region where the second handle extends from the second motor housing to thereby form a power drill, the percentage of the total combined weight of the second motor housing and the drill tool head which is disposed rearwardly of a forwardmost location of the region may be in the range of 25-75%.

When the sander tool head is attached to the first tool body at a forward surface of the first motor housing as defined relative to a region where the first handle extends from the first motor housing to thereby form a power sander, the percentage of the total combined weight of the first motor housing and the sander tool head which is disposed rearwardly of a rearwardmost location of the region may be in the range of 10-50%.

According to another aspect, an exemplary embodiment includes a sander tool head for a kit, the kit including a first tool body having a first motor housing and a first handle, the first handle disposed substantially mid-way between a front end and a rear end of the first motor housing, a DC motor having a first output shaft disposed within the motor housing, the first output shaft extending along a first output shaft axis; a second tool body having a second motor housing and a second handle, the second handle disposed substantially mid-way between a front end and a rear end of the second motor housing; an AC motor having a second output shaft disposed within the second motor housing, the second output shaft extending along a second output shaft axis, and a drill tool head removably attachable to both the first tool body and the second tool body, the drill tool head including a drill tool head driven shaft in driving engagement with the first output shaft when the drill tool head is attached to the first tool body and with the second output shaft when the drill tool head is attached to the second tool body, the drill tool head driven shaft in driving engagement with a drill head output spindle, the drill head output spindle extending along an axis which is substantially parallel to the first output shaft axis when the drill tool head is attached to the first tool body and along an axis which is substantially parallel to the second output shaft axis when the drill tool head is attached to the second tool body. The sander tool head may be removably attachable to both the first tool body and the second tool body, the sander tool head including a sander tool head driven shaft in driving engagement with the first output shaft when the sander tool head is attached to the first tool body and with the second output shaft when the sander tool head is attached to the second tool body, the sander platen having a sanding surface which extends substantially parallel to the first output shaft axis when the sander tool head is attached to the first tool body and to the second output shaft axis when the sander tool head is attached to the second tool body.

According to another aspect, there is an embodiment of a kit including a first tool body having a first motor housing and a first handle, the first handle disposed substantially mid-way between a front end and a rear end of the first motor housing, a DC motor having a first output shaft disposed within the motor housing, the first output shaft extending along a first output shaft axis. A second tool body has a second motor housing and a second handle, the second handle disposed substantially mid-way between a front end and a rear end of the second motor housing; an AC motor having a second output shaft disposed within the second motor housing, the second output shaft extending along a second output shaft axis. A drill tool head may be removably attachable to both the first tool body and the second tool body, the drill tool head including a drill tool head driven shaft in driving engagement with the first output shaft when the drill tool head is attached to the first tool body and in driving engagement with the second output shaft when the drill tool head is attached to the second tool body, the drill tool head driven shaft in driving engagement with a drill tool head output spindle, the drill tool head output spindle extending along an axis which is substantially parallel to the first output shaft axis when the drill tool head is attached to the first tool body and along an axis which is substantially parallel to the second output shaft axis when the drill tool head is attached to the second tool body. A saw tool head may be removably attachable to both the first tool body and the second tool body, the saw tool head including a saw tool head driven shaft in driving engagement with the first output shaft when the saw tool head is attached to the first tool body and with the second output shaft when the saw tool head is attached to the second tool body, the saw tool head driven shaft in driving engagement with a saw output shaft which is driven in reciprocating motion along an axis which is substantially parallel to the first output shaft axis when the saw head is attached to the first tool body and along an axis which is substantially parallel to the second output shaft axis when the saw head is attached to the second tool body.

### BRIEF DESCRIPTION OF THE DRAWINGS

FIG. 1 is a side view of a power tool according to an exemplary embodiment of the invention with a drill head attached;

FIG. 2 illustrates the power tool with the tool head detached;

FIG. 3 illustrates a drill head tool head attachment;

FIG. 4 is a perspective view of a coupling portion of the power tool base unit;

FIG. 5 is a perspective view of a coupling portion of the tool head;

FIG. 6 is a cut-away view showing the internals of the base unit with the drill tool head attached;

FIG. 7 is a cut-away view showing the internals of the base unit with the drill tool head detached;

FIG. 8 is a perspective view of a corded base unit;

FIG. 9 is a perspective view of a cordless base unit which receives a 3-cell battery pack;

FIG. 10 is a side view of a power tool according to an exemplary embodiment of the invention with a jig saw head attached;

FIG. 11 is a side view of a power tool according to an exemplary embodiment of the invention with a sander head attached;

FIG. 12 is a side view of a power tool according to an exemplary embodiment of the invention with an impact driver head attached;

FIG. 13 is a side view of a power tool according to an exemplary embodiment of the invention with a two speed hammer drill head attached;

FIG. 14 is a side view of a power tool according to an exemplary embodiment of the invention with a oscillating tool head attached;

FIG. 15 is a side view of a power tool according to an exemplary embodiment of the invention with a router tool head attached;

FIG. 16 is a side view of a power tool according to an exemplary embodiment of the invention with a trim saw head attached;

FIG. 17 is a side view of a power tool according to an exemplary embodiment of the invention with an inflator tool head attached;

FIG. 18 is a close-up side view of the power tool of FIG. 1 showing the center of gravity;

FIG. 19 is a close-up side view of the power tool of FIG. 11 showing the center of gravity;

FIG. 20 is a close-up side view of the power tool of FIG. 16 showing the center of gravity;

FIG. 21 is a side view of a power tool according to an exemplary embodiment of the invention with a reciprocating saw tool head attached;

FIG. 22 is a side view of the reciprocating saw tool head of FIG. 21; and

FIG. 23 is a cross-sectional view of the reciprocating saw tool head of FIG. 22.

### DETAILED DESCRIPTION OF EXEMPLARY EMBODIMENTS

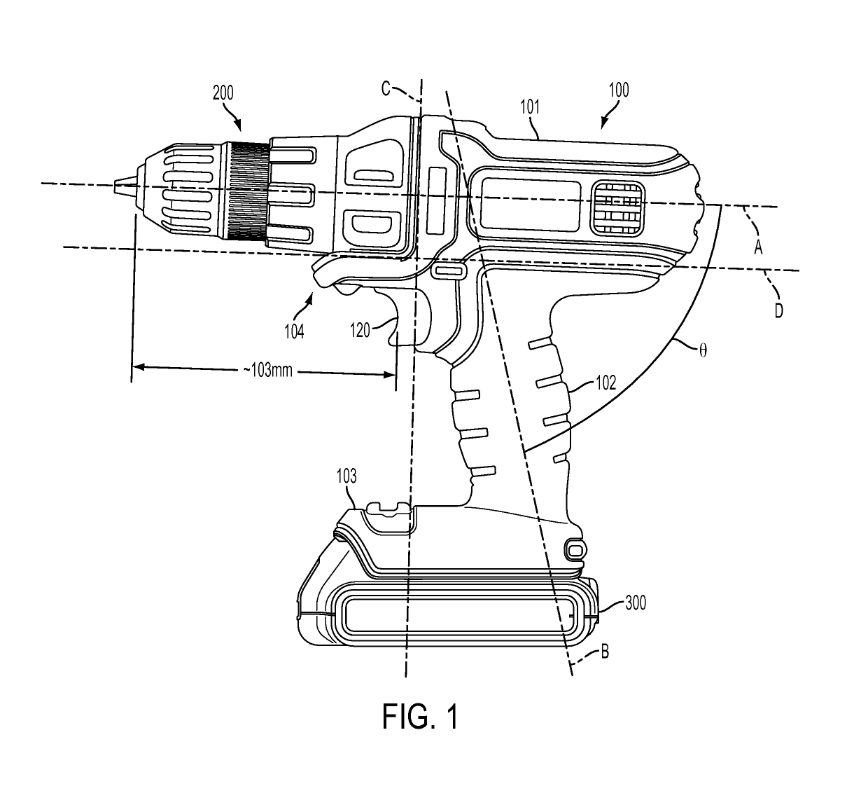

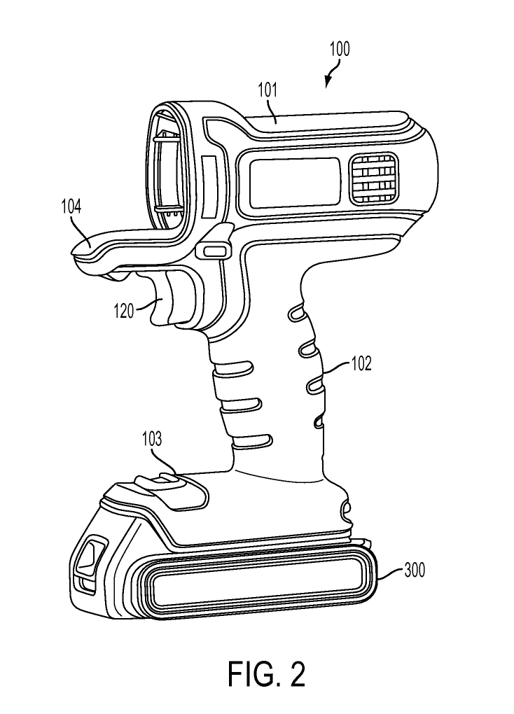

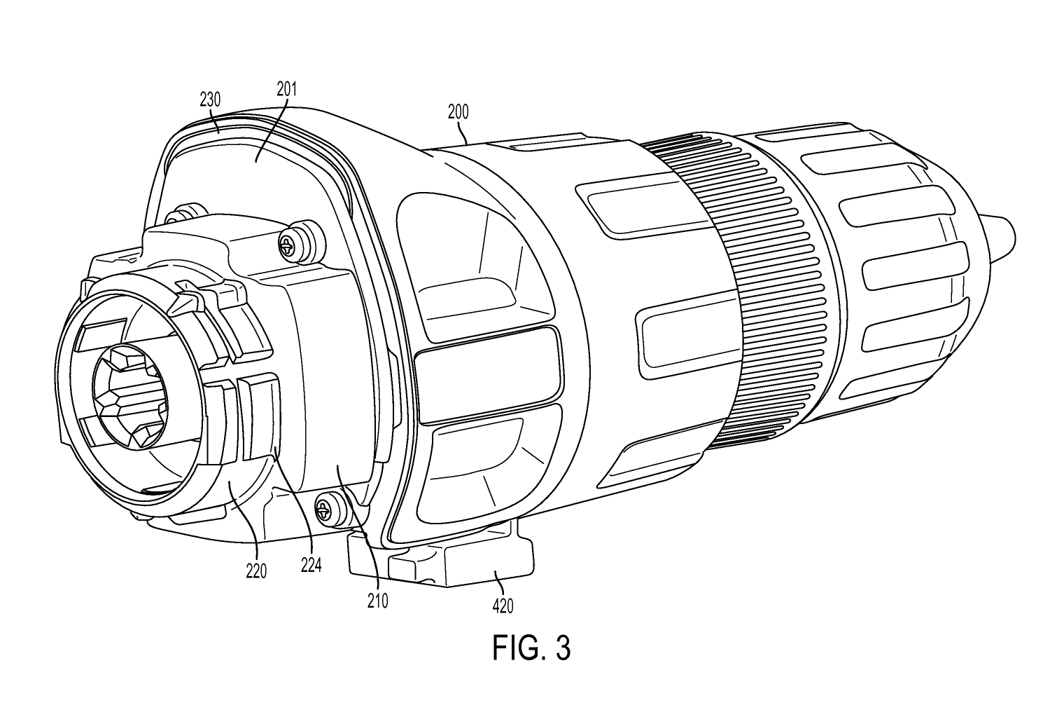

FIGS. 1-3 show an exemplary embodiment of a power tool according to the present application. FIG. 1 illustrates a cordless power tool base unit (tool body) with a drill as the power tool head. FIG. 2 shows the base unit alone and FIG. 3 shows the drill tool head alone.

As shown in FIGS. 1-3, the tool comprises a tool base unit 100 and a removably attached tool head 200. In this case the tool head 200 is a drill head. The tool base unit 100 includes a motor housing portion 101 a handle 102 extending from the motor housing portion and a foot 103 at the far end of the handle 102. The tool base unit 100 further includes a ledge 104 that helps to support the drill head 200. A trigger 120 is used to activate the motor 400.

As shown in FIG. 1, the motor housing has a longitudinal axis A. The longitudinal axis A is co-incident with the longitudinal axis of the motor housed in the motor housing 101. Additionally, the handle 102 has a longitudinal axis B. According to the exemplary embodiment, the handle 102 is located substantially mid-way between a front end and a rear end of the motor housing 101 and is substantially perpendicular to the motor housing 101. According to exemplary embodiments of the application, the angle θ between the longitudinal axis of the handle B and the longitudinal axis A of the motor housing 101 may be between 50 and 120 degrees. In FIG. 1, the handle 102 is substantially perpendicular to the motor housing 101 and it is contemplated that exemplary embodiments of the tool which have an angle θ between 65 and 115 degrees, and particularly between 70 and 110 degrees, provide good ergonomics for at least the drill tool head 200.

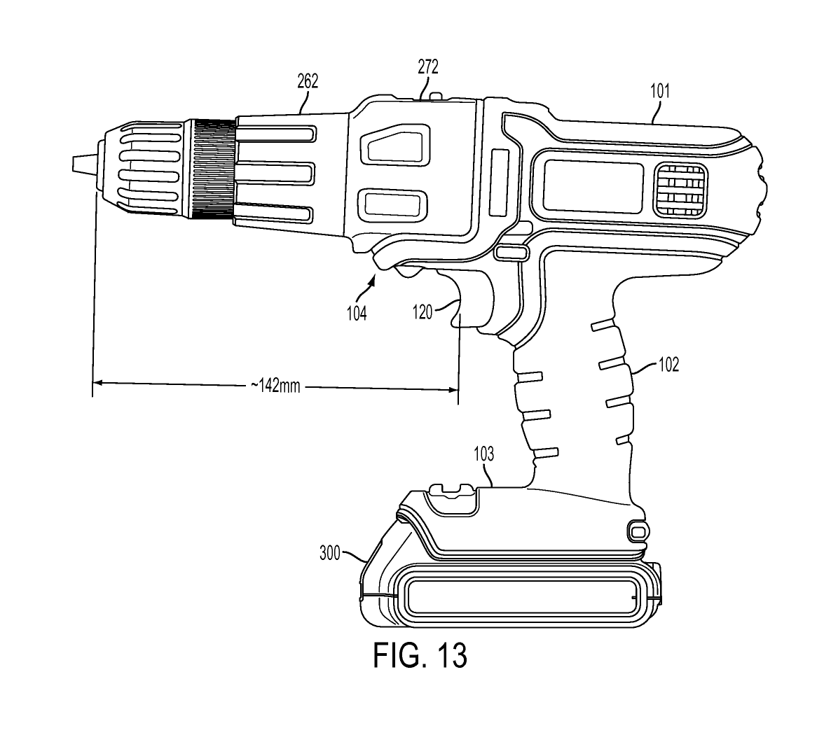

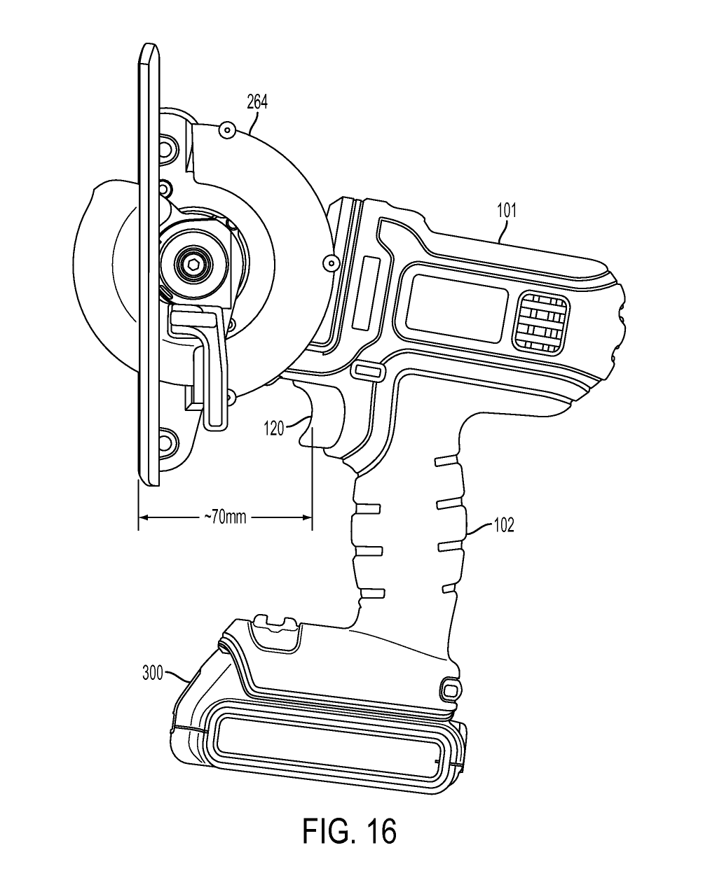

Typical power tools have only a single configuration and any tool head is not readily removable and interchangeable with other tool heads. Because the tool heads in such typical power tools are simply integrated into the power tool, the tool head is held in place by non-removable construction. In a power tool system with removable and interchangeable heads the tool head is removable and therefore not attached in the permanent manner of stand alone power tools. In an exemplary embodiment of the present application, there is provided a power tool system with a base unit with a ledge 104 which is substantially parallel to an axis of the motor 400 and/or the longitudinal axis A of the motor housing. The tool ledge 104 allows the tool to have a single mid-handle 102 that is angled with respect to the longitudinal axis A of the motor housing, while sufficiently supporting the tool head. Having a ledge 104 of this type also allows for a good portion of the tool head to be exposed so that controls can be exposed for the user on another side of the tool head (see, for example, the two speed hammer drill head 262 having a gear change shifter 272 as shown in FIG. 13). The design also allows for tool shapes such as the trim saw shown in FIG. 16 without unnecessarily increasing the distance between the power tool trigger and the work surface.

The drill head 200 and the tool base unit 100 meet at an interface C. The ledge 104 extends forward from this interface C and a line running through the interface intersects the trigger 120.

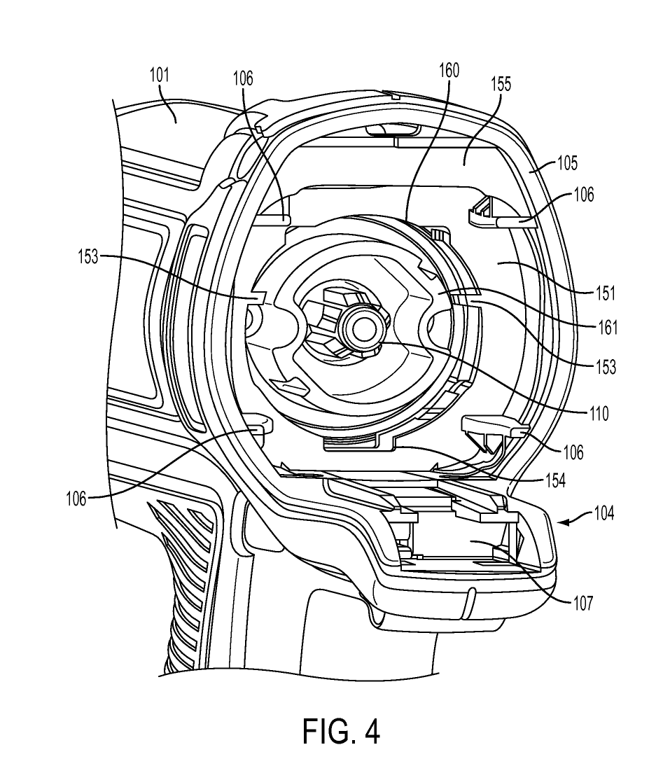

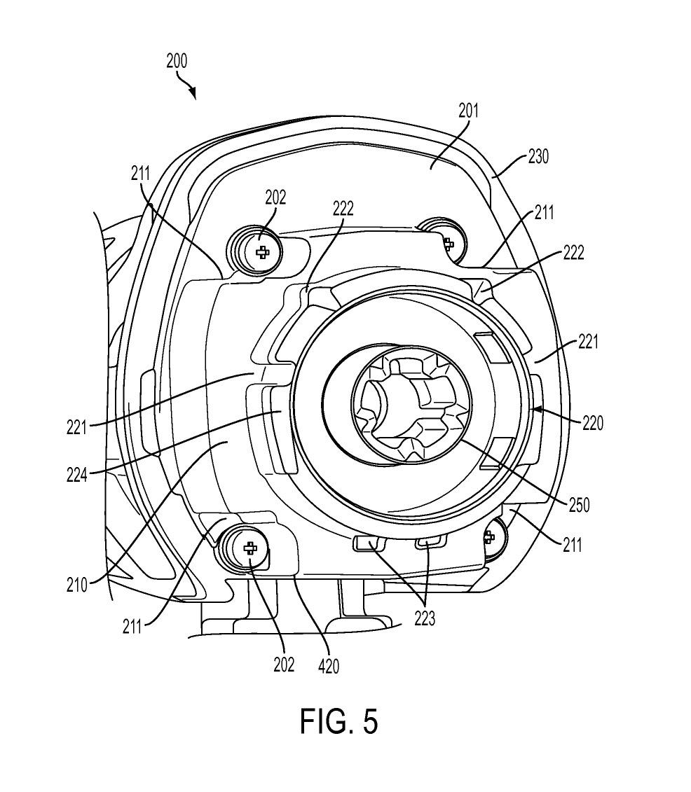

FIGS. 4 and 5 illustrate the coupling features of the tool base unit 100 and the tool head 200, respectively, in more detail. As shown in FIG. 4, the tool base unit 100 has a front face 105 of the motor housing 101. The front face 105 of the motor housing abuts against the rear face 230 of the drill head 200. The plane in which the front face 105 and the rear face 230 meet forms the interface C of FIG. 1.

As seen in FIG. 4, the base unit 100 has a generally circular opening 150 into which a coupling portion of the tool head 200 can be fit. Inside the circular opening 150, there is also a motor mount opening 160 which exposes the motor mount 161. A male coupler 110 which is coupled to the motor and spins with the motor shaft is at a center of the motor mount 161. The male coupler 110 transfers mechanical power from the tool base unit 100 to the tool head 200. Adjacent to the motor mount opening 160 is a first recessed face 151. The first recessed face 151 has several features for mating with the tool head 200, including slots 152, ribs 153 and cutout 154. There is a second recessed face 155 in a direction towards the tool head 200 and a plurality of ribs 106 at corners of the first recessed face 151.

Furthermore, as can be seen in FIG. 4, the ledge 104 has an opening 107 for receiving a contact plate 420 of the tool head 200. The contact plate 420 contacts a plate member 430 and together they serve as a lock-out as described in further detail in U.S. Patent Application 61/508,962, which is hereby incorporated by reference (the same reference numbers are not used in application 61/508,962 as in the present application).

The coupling portion of the tool head 200 is shown in FIG. 5. As shown in FIG. 5, the tool head 200 has a rear face 230 that abuts the front face 105 of the tool head when the tool head 200 is coupled to the tool base unit 100. Additionally, the tool head has a plate 201 that is screwed onto the rear face 230 with screws 202. A first protrusion 210 protrudes from the plate 201 towards the tool base unit 100. There are four receiving corners or slots 211 which receive the ribs 106 of the tool base unit 100.

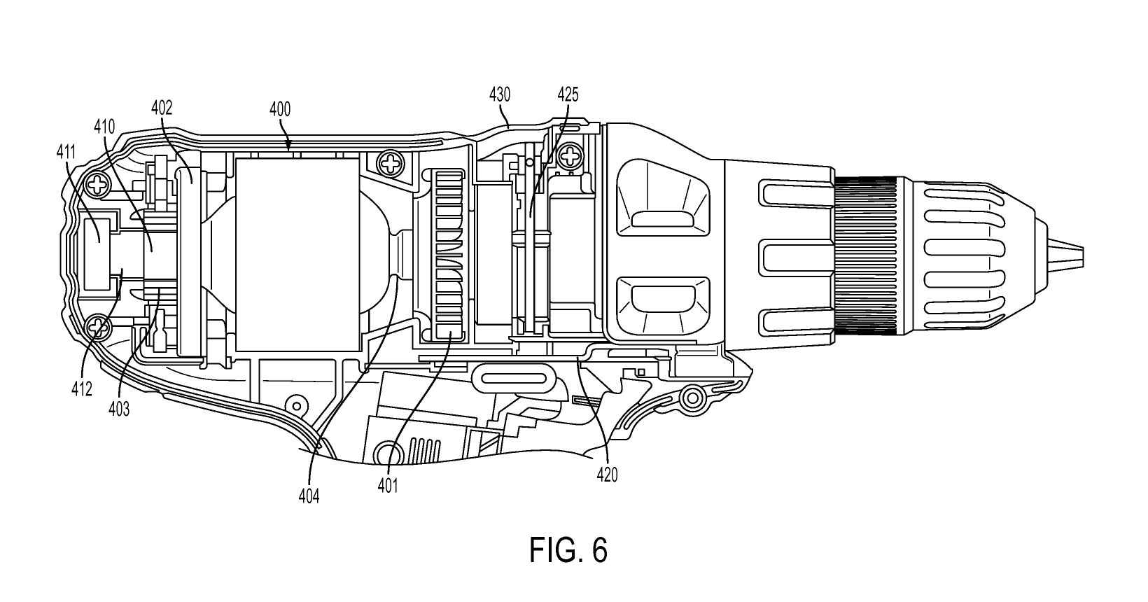

The tool head 200 coupling portion further includes a second protrusion portion 220 which extends from the first protrusion 210. The second protrusion portion 220 is generally cylindrical in shape. It includes slots 221 and ribs 222 and 223. It further includes a recess 224 which receives a spring 425 (see FIG. 6). When coupled to the tool base unit 100, the slots 221 receive the ribs 153, the protrusions 222 fit in the slots 152 and the ribs 223 slide into the cutout 154. Furthermore, the tool head 200 includes a female coupler 250 which engages the male coupler 110 of the tool base unit. Additionally, the spring 425 sets into the recess 224 to axially lock the tool head 200 in place. The spring 425 and recess 224 of the present application operate similarly to the spring and recess combination shown in U.S. Pat. No. 6,634,439, which is hereby incorporated by reference. While this exemplary embodiment shows the base unit coupler 110 being male and the tool head coupler 250 being female, these could be reversed. Similarly, the other various mating features could be reversed.

As shown in the exemplary embodiment, the features of the plate 201 directly mate with those of the motor mount 161. As can be appreciated, in a tool system with interchangeable heads according to an exemplary embodiment of the present application, the male coupler 160 is aligned with the female coupler 250 in order to transfer drive from the motor 400 to the tool head 200 and the output of the tool head 200. In the present exemplary embodiment, the motor 400 is clamped tightly into the motor housing 101 and the male coupler 160 and female coupler 250 have to be closely aligned. By making the tolerance alignment features on the plate 201 and the motor mount 161, as described above, unnecessary tolerance stack-up (as may be seen if the outside of the motor housing 101 were used for tolerance alignment) is avoided. That is, at least some of the features on the plate 201 and the motor mount 161 are used as alignment features. If features on the outside of housing of the drill head 200 were used in conjunction with features on the motor housing 101 to align the tool head 200 and the tool base unit 100, there can be a much more significant tolerance stack-up, because of the number of assembled parts between the alignment features and the male and female couples 110, 250, which are aligned to transfer power from the motor 400 to the tool head 200.

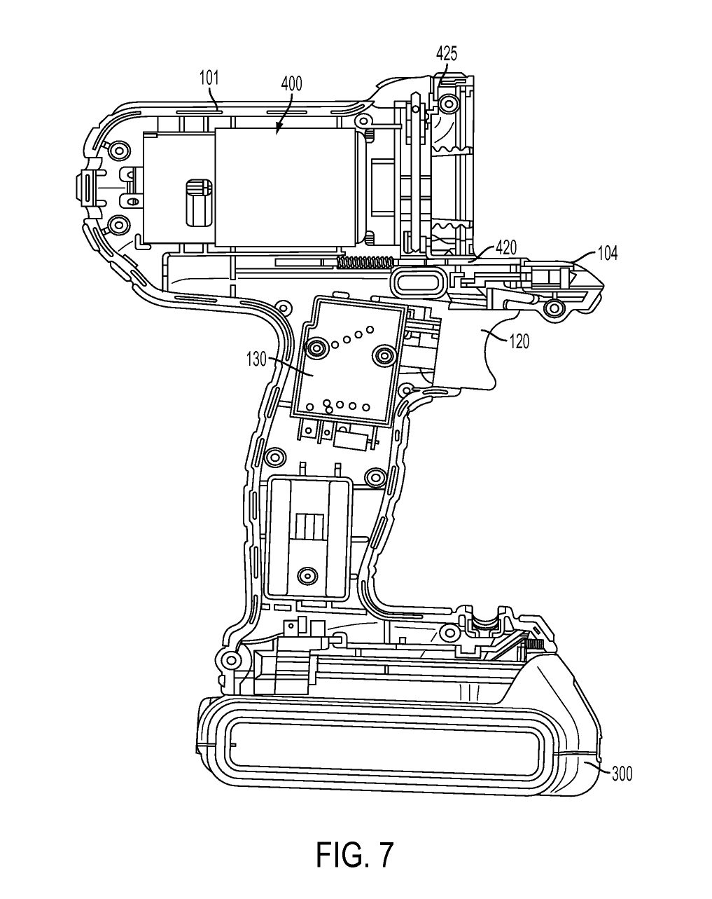

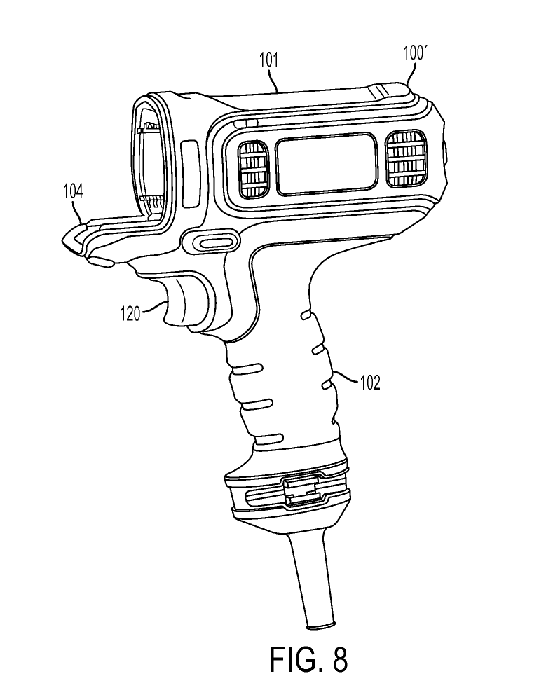

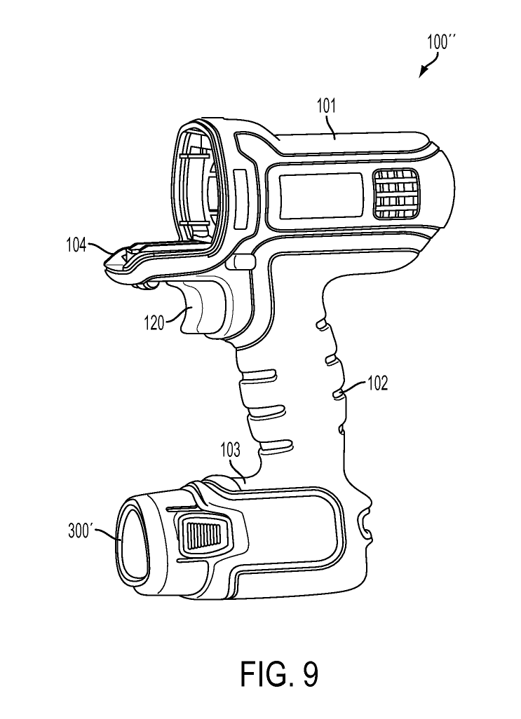

FIGS. 6 and 7 show internals of the base unit 100 (the base units 100′ of FIGS. 8 and 100″ of FIG. 9 includes similar internal features). As shown in these figures, the base unit 100 of the tool has a motor 400 (in the exemplary embodiment of FIG. 1 a DC motor; in the exemplary embodiment of FIG. 8 an AC motor). The motor 400 has a motor fan 401 at its front end for dissipating heat. The exemplary motor additionally has a brush ring 402 and a commutator 403. An output shaft 404 extends from the motor and provides drive to the male coupler 110. At its rear end, the motor 400 is supported by a shaft 410 which is partially covered by insulation 411. The shaft 410 may be integral and continuous with shaft 404 or may be a separate second shaft. At the rear end of the shaft 410, there is a bearing 411 supported in the housing. The motor 400 is activated by the variable speed trigger 120 and provides power to the base unit coupler 110.

As shown in FIG. 7, the trigger 120 is attached to a switch 130. Pulling the trigger 120 activates the switch 130 which in turn causes power to be provided to the motor. In this embodiment, the switch 130 and trigger 120 are variable speed, such that the speed of the motor 400 can be varied by pulling the trigger 120 more or less.

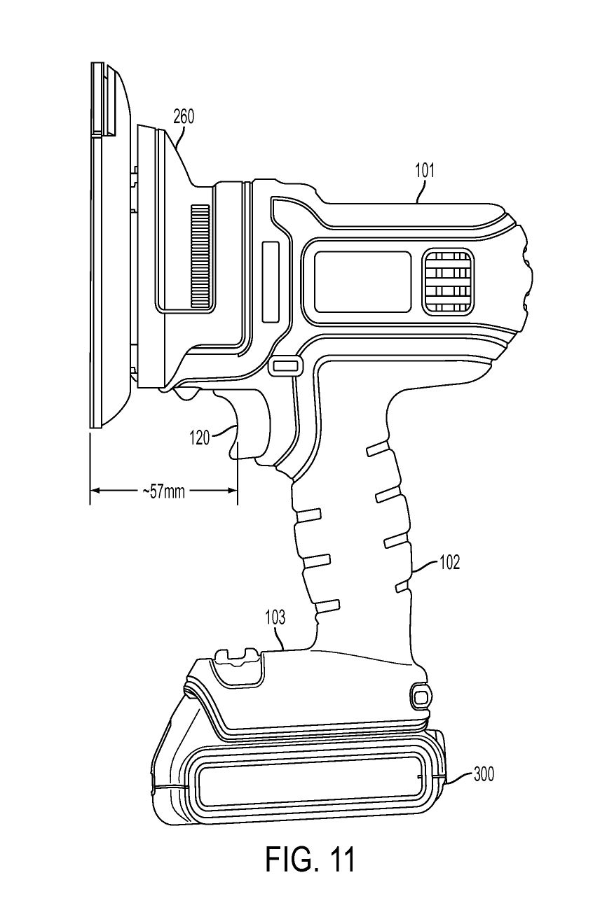

As shown in FIGS. 8 and 9, more than one type of tool base unit is contemplated. FIG. 1 shows a power tool base unit 100 which receives a slide-type battery pack 300. FIG. 8, on the other hand, is a corded base unit 100′ and receives AC power and has an AC motor. For the corded base unit 100′ shown in FIG. 8, the area at the bottom of the handle near where the cord is located is considered a foot. There may also be base units with different types of battery packs. For example, FIG. 9 shows a base unit 100″ which receives a 3-cell type battery pack. Other battery packs, such as a tower pack, are also contemplated. The battery packs may differ both in the mechanical interface and power/voltage. Additionally, the same tool head may fit into each of the different base units 100, 100′ and 100″. For example, the drill head 200 may fit into the base unit 100, as shown in FIG. 1, and alternatively into the base unit of FIG. 8 or FIG. 9. Likewise, when the sander head operates as the tool head, as shown in FIG. 11, it may fit into a base unit with a sliding battery pack as shown in FIGS. 1 and 11. It may also fit with the base units of FIGS. 8 and 9. This allows a user to have both a cordless and a corded system using the same tool heads.

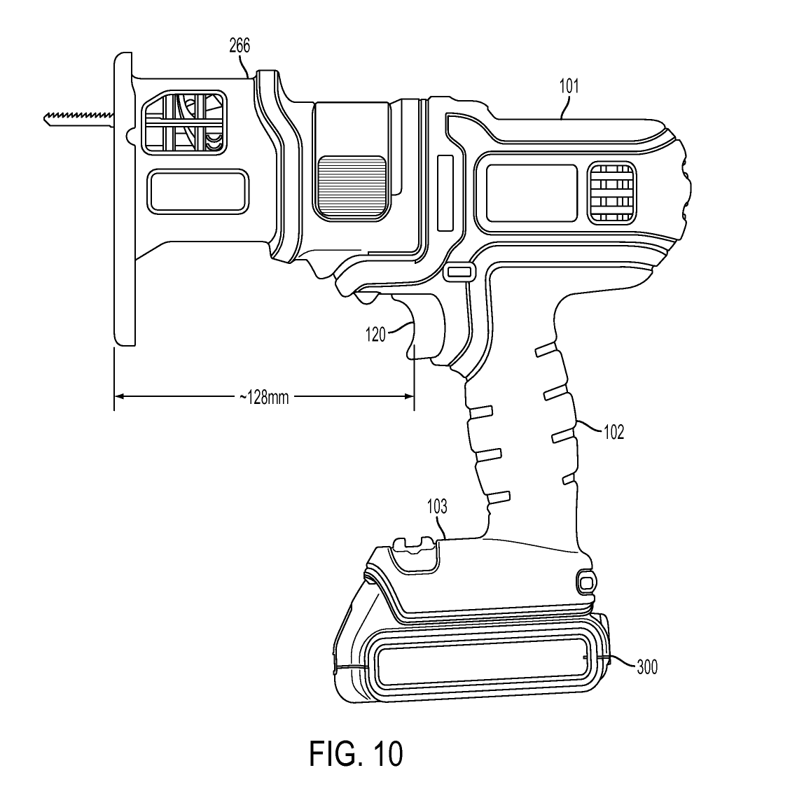

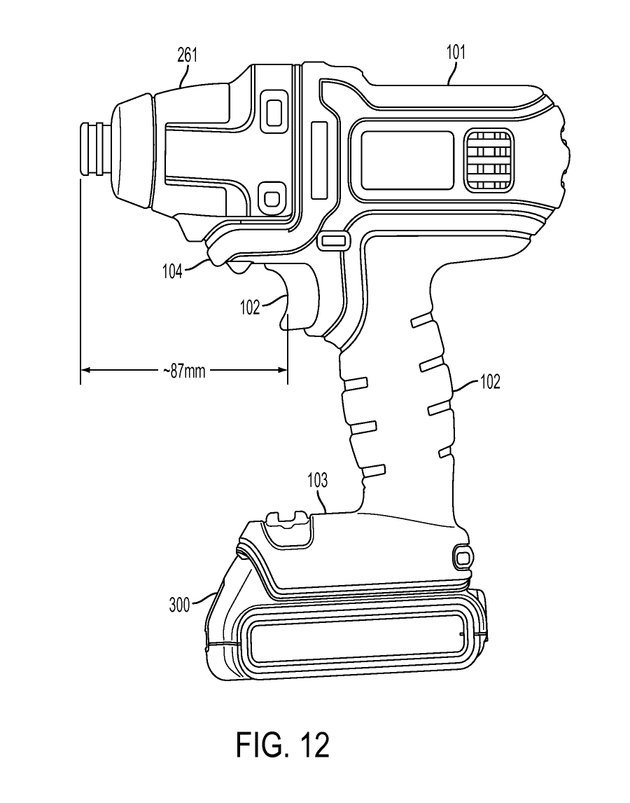

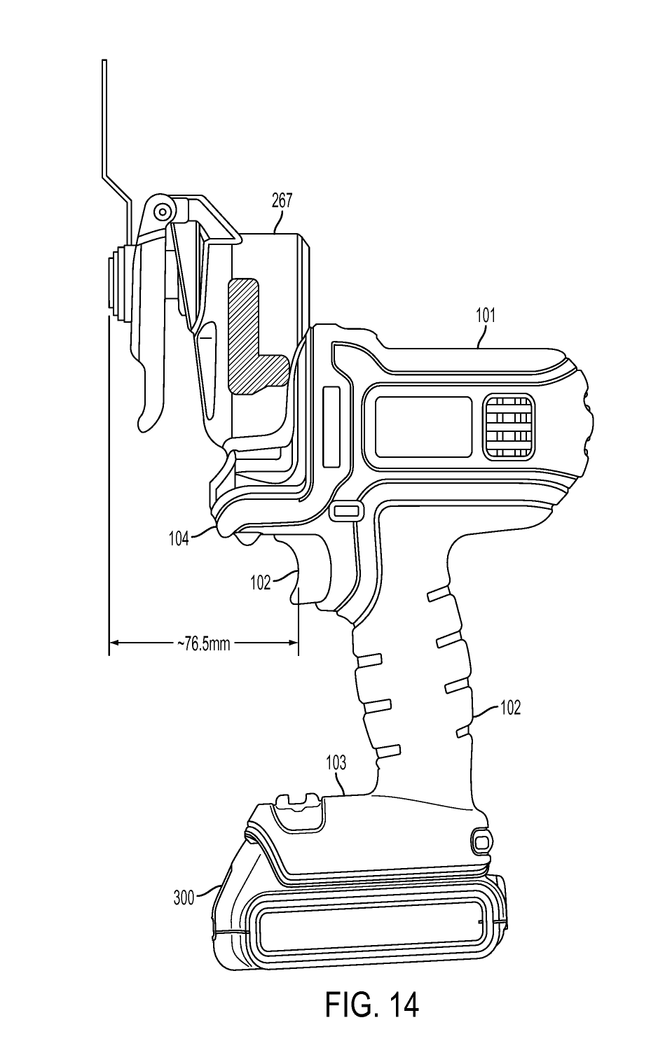

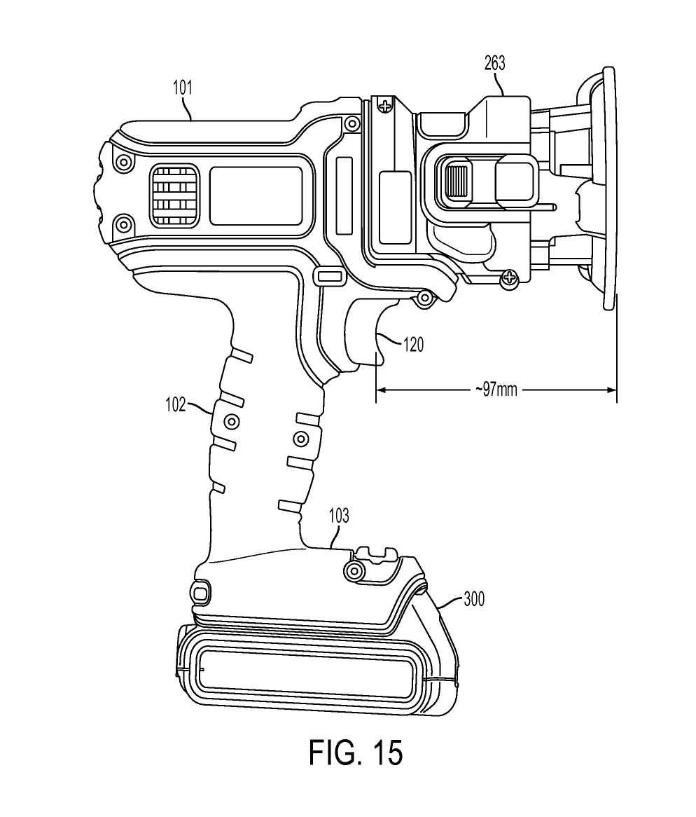

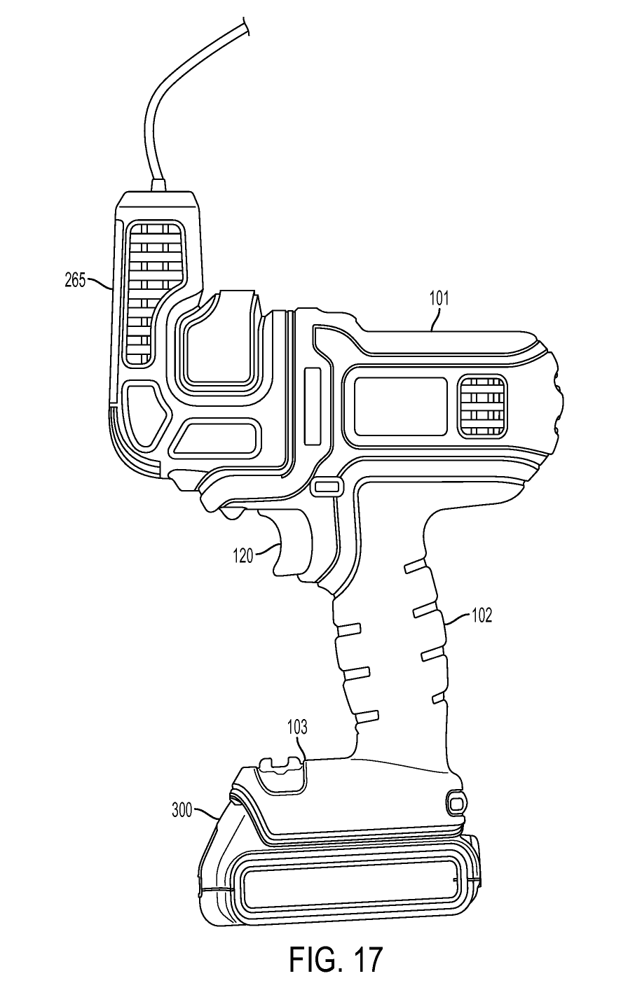

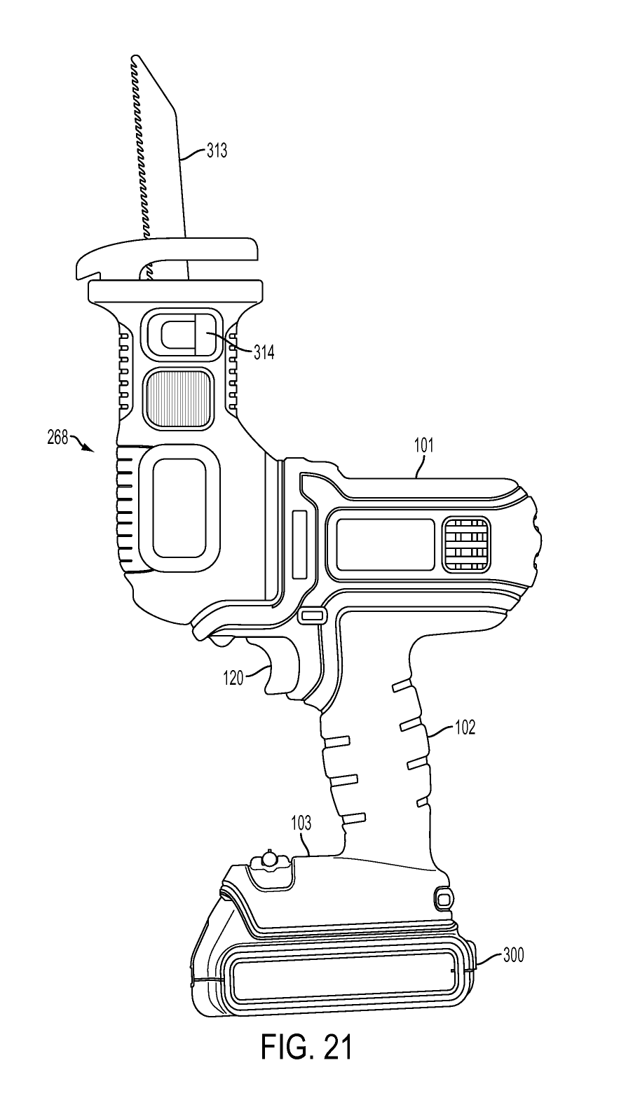

FIGS. 10-17 and 21 illustrate the power tool system with a variety of different tool heads. Particularly, FIG. 10 illustrates a jig saw head 266 FIG. 11 shows a sander head 260; FIG. 12 illustrates an impact driver 261; FIG. 13 illustrates a two speed hammer drill 262; FIG. 14 shows an oscillating tool 267; FIG. 15 illustrates a router 263; FIG. 16 illustrates a trim saw 264; FIG. 17 illustrates an inflator 265; and FIG. 21 illustrates a reciprocating saw 268. Each of these tool heads 260-268 have a coupling section as shown in FIG. 5 for the drill head 200. That allows each of the tool heads 260-268 to similarly fit with a base unit with a sliding battery pack as shown in FIGS. 10-17 and 21 or one of the other base units as shown in FIGS. 8 and 9. Each of these tool heads 260-268 have a coupling section as shown in FIG. 5 for the drill head 200. That allows each of the tool heads 260-268 to similarly fit with a base unit with a sliding battery pack as shown in FIGS. 10-17 or one of the other base units as shown in FIGS. 8 and 9. A variety of other power tool heads, including outdoor and/or cleaning tool heads, may be used with the power tool system.

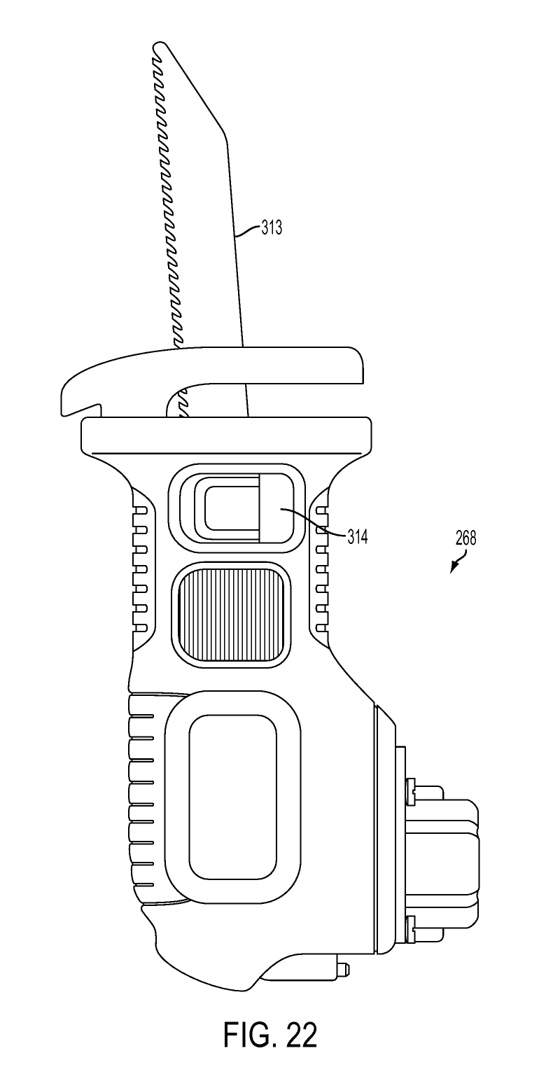

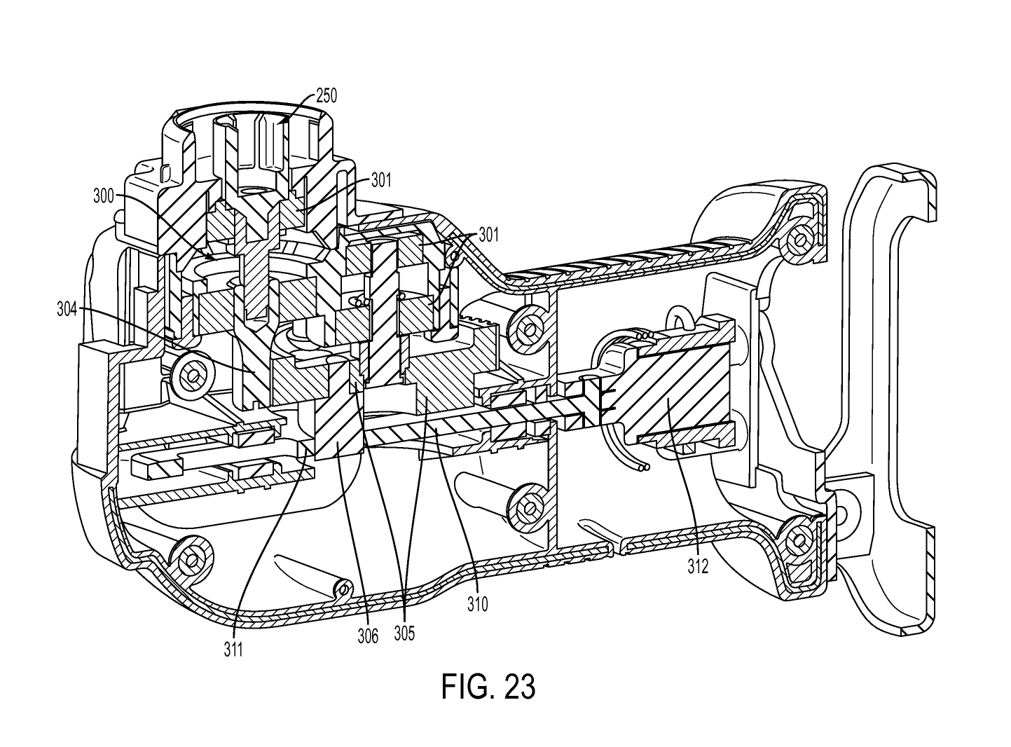

A cut-away view of the reciprocating saw tool head 268 is shown in FIG. 23. The reciprocating saw tool head of the exemplary embodiment uses a scotch-yoke mechanism, but other known reciprocating saw tool heads may also be used. In the reciprocating saw tool head, drive power is transmitted to the tool head through the female coupler 250, as with the other tool heads. That drive power is transferred through a transmission 300, including various bearings 301 and shafts 302, to a pinion 304. The pinion 304 has teeth which mesh with a drive gear 305. The drive gear 305 has a roller/sleeve bearing 306. The roller/sleeve bearing 306 is offset from the central axis of the drive gear 305, so that it rotates in a circular pattern as the drive gear 305 is rotated. In turn, the roller/sleeve 306 bearing engages with a hole 311 in the reciprocating shaft 310. Thus, as the roller/sleeve bearing 306 moves forward, it pushes the reciprocating shaft 310 forward and when the roller/sleeve bearing moves backward it pulls the reciprocating shaft 310 backwards to impart a reciprocating motion on the reciprocating shaft 310. A front end of the reciprocating shaft 310 has a blade clamp 312 which holds a saw blade 313 and can be released by means of a saw blade release lever 314 (see FIGS. 21 and 22).

As discussed above, the design of the exemplary embodiment of the power tool system shown in the present application allows for the work surface to be spaced an efficient distance from the tool trigger. As shown in the figures, the drill driver 200, impact driver 261, sander 260, router 264, trim saw 265 and oscillating 267 tool heads each have distances from the action point of the trigger 120 to the work surfaces which are less than 110 mm. The two speed hammer drill 262 is has a trigger to work surface distance that is somewhat longer due to the additional gears needed to provide a hammer mode and a gear change. However, it still has a trigger to work surface distance of less than 150 mm.

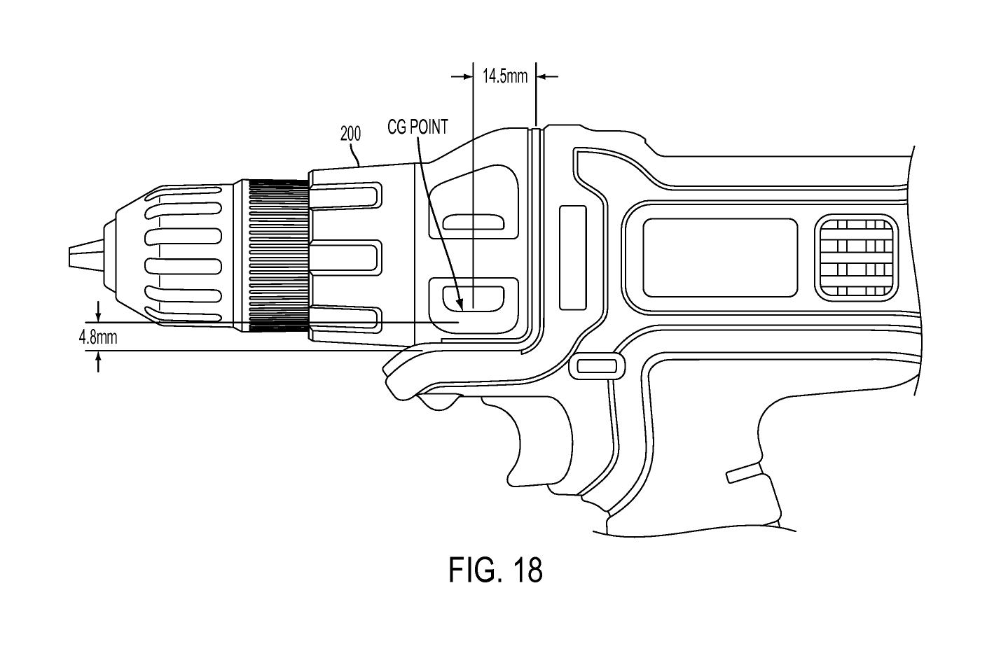

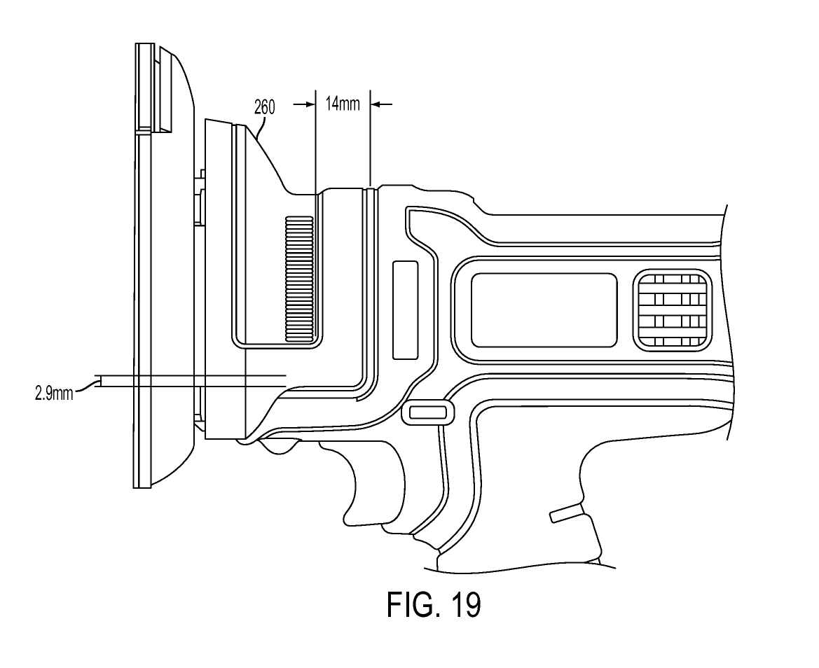

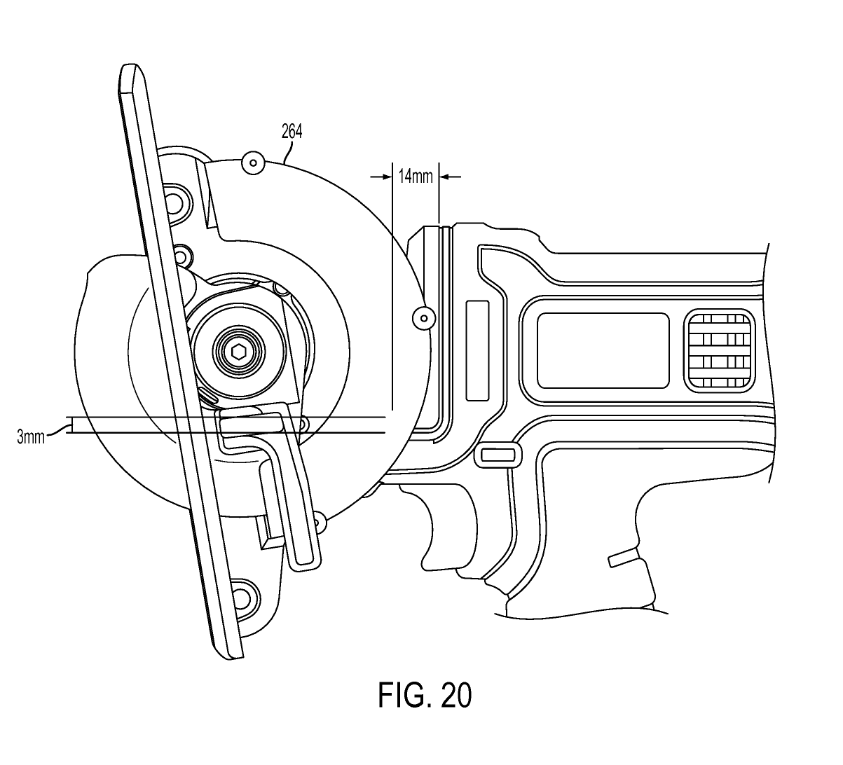

Furthermore, the configuration of the power tool system allows a center of gravity of the assembled power tool to be well placed for at least some of the most commonly used tool heads. FIG. 18 shows the center of gravity (CG) when the drill tool head 200 is attached. As shown in FIG. 18, when the drill tool head 200 is attached, the center of gravity of the power tool is located slightly above a top surface of the ledge (4.8 mm) and forward of the interface C (by 14.5 mm). This location is also slightly forward of the actuation point of the trigger. FIG. 19 shows the center of gravity (CG) when the sander tool head 260 is attached. As shown in FIG. 19, when the sander tool head 260 is attached, the center of gravity (CG) of the power tool is again located slightly above a top surface of the ledge 104 (2.9 mm) and forward of the interface C (by 14 mm). As with when the drill tool head is attached, the CG location is also slightly forward of the actuation point of the trigger. FIG. 20 shows the center of gravity (CG) when the trim saw tool head 265 is attached. As shown in FIG. 20, when the trim saw tool head 265 is attached, the center of gravity (CG) of the power tool is located slightly above a top surface of the ledge 104 (3 mm) and forward of the interface C (by 14 mm). As with when the drill tool head 200 and the sander head 260 are attached, the CG location is also slightly forward of the actuation point of the trigger.

A center of gravity location is beneficial for a number of reasons. Initially, by being located above the ledge 140, the center of gravity location allows for the tool heads to be well supported by the ledge and helps to facilitate the single, mid-handle design. Additionally, by having the CG less than 30 mm forward of the interface C, the ledge 140 does not have to be made unnecessarily long to support the CG. Additionally, that provides a CG near the actuation point of the trigger.

According to another aspect of the present application, the weight of the power tool with respect to a region where the handle extend from the motor housing is designed for ergonomic usage of different tool heads. As discussed above, exemplary embodiments of the present application improve the ergonomics of a power tool system with interchangeable heads. Therefore, according to one aspect of the present application, the percentage of weight when the sander tool head 200 is attached to the base unit 100 shown in FIG. 1 or the base unit 100′ shown in FIG. 8, at a forward surface of the motor housing as defined relative to a region where the handle extends from the motor housing to thereby form a power sander, the percentage of the total combined weight of the motor housing and the sander tool head which is disposed rearwardly of a rearwardmost location of said region is in the range of 10-50%. The ergonomics can be further improved when the percentage is in the range of 20-40% and yet further improved as the weight is in the range of 25-35%. When measured from the forwardmost location of the region, the percentage is in the range of 25-75%, ergonomics are improved when the range is in 35-65% and further improved if the percentage is within the range of 45-55%. When a drill tool head 200 is used, the percentage of weight of the exemplary embodiment is in the same range, thus providing a consistent experience for the user for two of the most widely used handheld power tools.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied. Such variations are not to be regarded as a departure from the invention and all such modifications are intended to be included within the scope of the invention.

Example embodiments are provided. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

1. A power tool comprising:
a power tool base unit, the base unit including:
a housing and a motor surrounded by the housing;
a first coupler operably connected to the motor;
a trigger for activating the motor;
a foot;
a ledge; and
a single handle disposed between the motor housing and the foot;
the power tool further comprising an attachment head removably attached to the base unit, the attachment head including a second coupler, the first and second couplers being coupled together when the attachment head is attached to the base unit;
wherein an angle between a longitudinal axis of the handle and a longitudinal axis of the motor is between 50 and 120 degrees; and
wherein the ledge extends outwardly from the power tool base in a direction towards the attachment head in a direction substantially parallel to the longitudinal axis of the motor.

2. The power tool of claim 1, wherein the attachment head is a sander head and a distance from an action point of the trigger to a work surface is less than 110 mm.

3. The power tool of claim 1, wherein there are at least two attachment heads which may be selectively attached and removed from the base unit and wherein when each of the at least two attachment heads is attached to the base unit, a distance from an action point of the trigger to a work surface is less than 150 mm.

4. The power tool of claim 3, wherein the at least two attachment heads comprise a drill head and a sander head.

5. The power tool of claim 3, wherein the at least two attachment heads comprise a drill head, a sander head and a saw head.

6. The power tool of claim 1, wherein there are at least two attachment heads which may be selectively attached and removed from the base unit and wherein when each of the at least two attachment heads is attached to the base unit, a distance from an action point of the trigger to a work surface is less than 110 mm.

7. The power tool of claim 6, wherein the at least two attachment heads comprise a drill head and a sander head.

8. The power tool of claim 3, wherein a center of gravity of the tool when either of the two tool heads is connected to the base unit is less than 30 mm forward of an interface where the base unit and the tool heads meet.

9. The power tool of claim 3, wherein a center of gravity of the tool when either of the two tool heads is connected to the base unit is less than 20 mm forward of an interface where the base unit and the tool heads meet.

10. The power tool of claim 1, wherein the attachment head is at least partially supported by the ledge.

11. The power tool of claim 1, wherein the ledge extends forward of the trigger.

12. A power tool comprising:
a power tool base unit, the base unit including:
a motor surrounded by a motor housing;
a first coupler operably connected to the motor;
a trigger for activating the motor;
a foot; and
a single handle disposed between the motor housing and the foot;
an attachment head removably attached to the base unit, the attachment head including a second coupler, the first and second couplers being coupled together to transfer rotational motion from the motor to the attachment head when the attachment head is attached to the base unit;
wherein the base unit and the attachment head define an interface surface where the base unit and the attachment head meet; and
wherein the trigger lies on a line that runs along the interface surface.

13. The power tool of claim 12, wherein an angle between a longitudinal axis of the handle and a longitudinal axis of the motor is between 50 and 120 degrees.

14. The power tool of claim 13, wherein a motor mount is attached to the motor and a plate is attached to a rear face of the tool head and the motor mount and the plate have complementary alignment features which align the first and second couplers.

15. The power tool of claim 12, wherein a longitudinal axis of the handle and a longitudinal axis of the motor housing are substantially perpendicular to one another.

16. The power tool of claim 13, wherein there are at least two attachment heads which may be selectively attached and removed from the base unit and wherein when each of the at least two attachment heads is attached to the base unit, a distance from an action point of the trigger to a work surface is less than 150 mm.

17. The power tool of claim 16, wherein a center of gravity of the tool when either of the two tool heads is connected to the base unit is less than 30 mm forward of an interface where the base unit and the tool heads meet.

18. The power tool of claim 16, wherein a center of gravity of the tool when either of the attachment heads is connected to the base unit is less than 20 mm forward of an interface where the base unit and the tool heads meet.

19. The power tool of claim 18, wherein the base unit further comprises a ledge extending outwardly from the in a direction towards the attachment heads and substantially parallel to the longitudinal axis of the motor; and
wherein the ledge at least partially supports a lower surface of an attachment head when the attachment head is connected to the base unit.

20. The power tool of claim 12, wherein the attachment head comprises a reciprocating saw head; and
wherein the reciprocating saw head comprises a reciprocating shaft which reciprocates in a direction substantially perpendicular to a longitudinal axis of the motor.
